(19) United States
(12) Patent Application Publication
(10) Pub. No.: US 2007/0010415 A1
(43) Pub. Date: Jan. 11, 2007

(54) Composition for Visibility and Impact of Suspended Materials

(76) Inventors: Kevin Kinscherf, Freehold, NJ (US); Karen Wisniewski, Bound Brook, NJ (US); Janine Chupa, Princeton, NJ (US); Melissa Fleckenstein, Clark, NJ (US); Kenneth Reed, North Plainfield, NJ (US); Regina Recchia, Succasunna, NJ (US); Mohamed Omer, Piscataway, NJ (US)

Correspondence Address: COLGATE-PALMOLIVE COMPANY, 909 RIVER ROAD, PISCATAWAY, NJ, 08855, US

(21) Appl. No.: 11/532,227

(22) Filed: Sep. 15, 2006

Related U.S. Application Data
(63) Continuation-in-part of application No. PCT/US06/15108, filed on Apr. 21, 2006.
(60) Provisional application No. 60/673,685, filed on Apr. 21, 2005.

(51) Int. Cl. C11D 3/02

(52) U.S. Cl. 510/218

(57) ABSTRACT

This application relates to the visual impact of suspended materials in a liquid composition.

### CROSS REFERENCE TO RELATED APPLICATIONS

This application is a continuation in part of PCT/US2006/015108, filed on 21 Apr. 2006, which claims priority to U.S. Provisional Patent Application Ser. No. 60/673.685, filed on 21 Apr. 2005, both of which are incorporated herein by reference.

### BACKGROUND OF THE INVENTION

Structured liquids are known in the art for suspending materials such as beads in liquid cleaning compositions. The methods of providing structure to the liquid includes using particular surfactants to structure the liquids or by the addition of structuring agents such as polymers, natural gums and clays which enable the liquid to suspend materials therein for long periods of time. These suspended materials can be functional, aesthetic or both. By aesthetic it is meant that the suspended materials impart a certain visual appearance that is pleasing or eye catching. By functional it is meant that the suspended materials contribute to the action of the composition in cleaning, fragrance release, shine enhancement, or other intended action of the composition.

The suspension of materials, however, in a structured cleaning liquid composition by the aforementioned use of surfactants, polymers, natural gums and clays has characteristics that consumers often do not associate with acceptable liquid dish detergents. Conventional structured liquids are often opaque or turbid thereby obscuring the visual appeal to the consumer of the suspended materials which are shown to best advantage in a nearly transparent or clear liquid.

Further a by-product of structuring a liquid to suspend materials causes a significant increase in liquid viscosity and a corresponding decrease in liquid pourability and ease of dissolution in water. Both properties are generally not considered consumer acceptable, particularly, in liquid cleaning products like hand dishwashing liquid. Still further, the structured liquid with suspended materials must be able to provide good cleaning and manifest the foaming and rinsing properties which consumers today expect from a commercial liquid detergent. Finally, the dissolution rate of the structured liquid in water is desired to be rapid so that foam generation is not delayed. Foam is a signal to consumers that the detergent is high quality. Pourability and dissolution are in part linked to liquid viscosity.

Even further, adding materials such as beads and structure to an othenvise un-beaded un-structured product adds cost. Therefore, it would be desirable to enhance the visual impact of such materials in a liquid detergent product. The visual impact can include both the liquid composition and the packaging.

The liquid detergent by necessity must be distributed to the consumer in a labeled container. Labeling can obscure the viewability of the product in the bottle. It would be desirable to produce a liquid detergent with suspended material to provide an acceptable visual impact.

### BRIEF SUMMARY OF THE INVENTION

A composition comprising suspended material and a liquid portion comprising at least one surfactant, wherein
a) the surfactant is present in the composition in an amount that is at least 15% by weight of the composition based on active weight of the surfactant:
b) the composition has a viscosity less than 10,000 mPas as measured at 25° C.;
c) the liquid portion has a transmittance, as measured by visible spectroscopy, of at least 15%; and
d) the suspended material has a particle size of 100 to 2500 microns.

### DETAILED DESCRIPTION OF THE INVENTION

As used throughout, ranges are used as shorthand for describing each and every value that is within the range. Any value within the range can be selected as the terminus of the range.

Unless otherwise stated, references to weight % in this specification are on an active basis in the total composition.

This invention teaches how to enhance the aesthetic benefits of surfactant containing compositions with suspended materials. These materials are defined as water insoluble visible particles. They can be functional or non-functional, i.e. functional materials have components that augment the performance capabilities of the product and non-functional materials are present solely for aesthetic purposes. Functionality can often be provided by encapsulating materials that deliver functional benefits or by providing a tactile benefit (e.g. scrubbing). Functional materials, however, may also have aesthetic purposes. It has been found that it is desirable to take the entire product (package and the liquid composition) into consideration to enhance the appearance (visual impact) of materials. Since suspended materials add cost to normally unit-beaded detergent liquid maximizing their appearance is important to success in the market place.

The composition comprises at least one surfactant in a liquid portion and suspended material. The liquid portion refers to the part of the composition that is not the suspended material. The combination of the suspended material in the composition provides a desired aesthetic appearance. The composition is fornulated to provide for the following combination of properties, the ability to suspend materials, desired clarity, a pourable viscosity, and enhanced visible impact.

The suspended material can be density matched to the liquid portion if very low viscosity is desired. Density matched means that the density of the suspended material is close to the density of the liquid portion so that the suspended material remains suspended. In one embodiment, the density of the suspended material has a density that is 97% to 103% of the density value of the liquid portion.

The composition can be formulated to be any type of detergent composition. The composition can be used as a light duty liquid (LDL) dish detergent, hand soap, body wash, or a laundry detergent. One embodiment described below will be for a dish detergent.

Liquid Clarity

The composition has a clarity that provides for at least 15% transmittance as measured by the test described below. In other embodiments, the transmittance is >50%, >90%, or up to 100%. The transmittance is measured in the liquid portion. Transmittance is usually decreased by the addition of coloring material (pigments or dyes) to the formula. The addition of any coloring agent to the liquid portion must not decrease the transmittance below the minimum 15% specified. It is unlikely that a colored composition would have a 100% transmittance, although a very pale color in a detergent composition of high clarity can approach this limit.

Color

The liquid portion, the suspended material, the container, and the label can each individually be colored or uncolored as long as the suspended material is visually detectable to an observer. Color can be measured by the L*a*b* system established by the Commission Internationale d'Eclairage (CIE). (See for example, McClelland, D.. Macworld® Photoshop® 4 Bible, IDG Books Worldwide, Inc. 1997, pp. 157-184.) Color can also be measured by the L*C*h° system also established by Commission Internationale d'Eclairage (CIE). This system is very comparable to how human subjects describe colors, representing the terms “lightness”, “chroma”, and “hue”. L* refers to the lighness/darkness of a color. C*, chroma, refers to the intensity of the color, for instance how intensely red the red is. Hue, h°, refers to what people generally refer to as “color”—red, blue, green, orange and is given as an angle. Unlike the L*a*b* system which operates on a standard Cartesian system, L*C*h° operates on a polar coordinate system. Color differences that are significant can be specified by the AECMC tolerancing system based on CIELCH and devised by the Color Measurement Committee of the Society of Dyers and Colourists in Great Britain. By this system, it can be seen that there minimum distances between colors for the colors to be seen as different, and these differences vary with hue and chroma.

In one embodiment, it is desired to have a liquid portion hue or container hue that is not complementary to at least a portion of the suspended material hue, that is having a liquid portion hue or container hue that is not 180 degrees away from the suspended material hue on a standard color wheel, or any color visually indistinguishable from the oppositional color. In other embodiments, the liquid portion hue and/or container hue is not complementary to more than 50%. more than 60%, more than 70%, more than 80%, more than 90%, more than 95%, or more than 99% of the suspended material hue. The color of the suspended material can be altered by viewing it through the liquid portion and the package if the color of those items is not completely colorless. When viewed through and surrounded by a complementary color, the color of the suspended material tends to have a strong gray cast, in which the brightness and impact of the suspended material color is less than it could be, which may not be a desired affect. If multiple suspended material colors are used, the liquid portion hue or container hue preferably should not be complementary to any of the suspended material colors. If the liquid portion or container hue is complementary to the suspended color (whether single or multiple suspended material color), then the liquid portion or container color should have the lowest chroma possible. The appearance of the suspended material is more impactful if the chroma of the liquid portion or container is different from the chroma of the suspended material color.

In one embodiment, it is desired that the visual intensity, or chroma, of the colors of the liquid portion and the container are coordinated. The overall transmittance of the liquid porition and container are selected to allow the suspended material to be visible. The transmittance of the liquid portion and that of the container are due to its clarity and its color. It is also desirable to provide visual contrast between the suspended material, the liquid portion, and the container. The chroma of the liquid portion and container can thus be chosen to be different from the chroma of at least a portion of the suspended material. In other embodiments, the chroma of the liquid portion and/or container are different from more than 50%, more than 60%, more than 70%. more than 80%, more than 90%, more than 95%, or more than 99% of the suspended material chroma. This differentiation by chroma can be used if the hue of the suspended material is close to that of the hue of the liquid portion or container so that the suspended material is visually detectable. The clarity of the liquid portion and the clarity of the container should also be maximized so that the maximum light is passed to illuminate the suspended material.

The chroma and hue of the liquid portion and that of the container can match or be different depending on the aesthetic effect desired. In one embodiment, the chromas of the liquid portion and the container can be the same as long as the transmittance through the container and the liquid portion meet the stated limits for transmittance. In another embodiment, the hue of the container and the hue of the liquid portion should not be 180 degrees apart from each other on a standard color wheel or any color that is visually indistinguishable from the oppositional color.

Suspended Materials

At least a portion of the suspended material is of any size that is viewable by a person. By viewable it is meant that the suspended material can be seen by a non-color blind person with an unaided eye at 20/20 or corrected to 20/20 with glasses or contact lenses at a distance of 30 cm from the composition under incandescent light, florescent light, or sunlight. In other embodiments, at least 50%, at least 60%, at least 70%, at least 80%. at least 90%, at least 95%, or at least 99% of the particles are viewable by a person. In one embodiment, the particle size is 100 to 2500 microns in a longest dimension of the suspended material. In another embodiment, the particle size is 250 to 2250 microns. In another embodiment, the particle size is 500 to 1500 microns. In another embodiment, the particle size is 700 to 1000 microns. In another embodiment, a combination of more than one particle sizes can be used. In another embodiment, there is a combination of five particle sizes.

The suspended material can have any shape. Examples of shapes include, but are not limited to, spherical, polyhedral, cubic, box, tetrahedral, irregular three dimensional shapes, flat polygons, triangles, rectangles, squares. pentagons, hexagons, octagons, stars, characters, animals, plants, objects, cars, or any other desired shape.

The suspended material can be present in any amount in the composition that allows the suspended material to remain suspended. In one embodiment, the suspended material is present in an amount of 0.01 and 10% by weight of the total composition.

The suspended material can be selected to be of one size and one shape, one size and a combination of shapes, a combination of sizes and one shape, or a combination of sizes and a combination of shapes. Also, the color of the suspended material can be varied along with the size and/or shape. Mixtures of suspended materials that vary by size, shape, and/or color can be used to communicate different attributes that the product can deliver to a consumer.

The suspended material can be functional, non-functional, or a combination of both. They can be made from a variety of materials such as the following non-limiting examples: gelatin, cellulose, agar, waxes, polyethylene, and insoluble inorganic materials like silica and calcium carbonate. The material may also have an encapsulate core containing hydrophobic compounds and mixtures such as these non-limiting examples: aloe, vitamins, essential oils, natural oils, solvents, esters, or any fragrance ingredient. These materials may be density matched by encapsulating oils or other materials that help make the density of the suspended material equal to that of the bulk composition. Alternatively, they may be made porous in a way that allows the liquid portion to diffuse into the suspended material in a manner that is self density matching. Density matching produces compositions that can suspend material at a viscosity less than 1500 mPas. Also, the particles may be non-density matched, that is being either less or more dense than the composition. In these compositions, the liquid portion can be designed to have a yield stress to aid in the stabilization of suspended material.

While the composition can be formulated to suspend material without the need of a suspending agent, suspending agents can be added to increase the stability of the suspended material to keep the material suspended. The composition can be stored in warehouses anywhere in the world. Temperatures can range from very cold to very hot. As temperatures change, the density of the liquid may be different from the density of the suspended material. The composition can be formulated to keep the suspended matter suspended at both temperature extremes.

Suspending Agents

Suspending agents are any material that increases the ability of the composition to suspend material. Examples of suspending agents include, but are not limited to, gellan gums, polymeric gums, polysaccharides, pectine, alginate, arabinogalactan, carageenan, xanthum gum. guar gum, rhamsan gum, furcellaran gum, and other natural gum. A synthetic structuring agent in one embodiment is a polyacrylate. One acrylate aqueous solution used to form a stable suspension of the solid particles is manufactured by Noveon as CARBOPOL™ Aqua 30. The CARBOPOL™ resins, also known as CARBOMER™, are hydrophilic high molecular weight, crosslinked acrylic acid polymers having an average equivalent weight of 76, and the general structure illustrated by the following formula has a molecular weight of about 1,250,000; CARBOPOL™ 940 with a molecular weight of approximately 4,000,000 and CARBOPOL™ 934 with a molecular weight of approximately 3,000,000. The CARBOPOL™ resins can be crosslinked with polyalkenyl polyether, e.g. about 1% of a polyalkyl ether of sucrose having an average of about 5,8 alkyl groups for each molecule of sucrose.

The suspending agents can be used alone or in combination. The amount of suspending agent can be any amount that provides for a desired level of suspending ability. In one embodiment, the suspending agent is present in an amount from about 0.01 to 10% by weight of the composition. In one embodiment, gellan gum is included in the composition.

Stability of Suspended Particles

The composition can keep the suspended materials suspended for at least 2 weeks at room temperature (23-25° C.). By suspended it is meant that at least 90%, or at least 95%, or at least 97%, or at least 99% of the suspended material remains suspended in the composition without settling out to the bottom of the liquid portion. This is measured by counting the number of particles that remain suspended in the liquid portion after the elapse of time as compared to the number of particles in the liquid portion initially. In other embodiments. the suspended material can be suspended for at least two months, at least six months, or at least one year at room temperature (23-25° C.). In other embodiments, the composition can keep the suspended materials suspended for at least 18 weeks at 40.5° C. (105° F.). In another embodiment, the composition can keep the suspended material suspended for at least 2 weeks at −10° C. In another embodiment, the composition can keep the suspended material suspended for at least 3 weeks at 4.5° C. While factors such as the amount of Surfactant, the size of the suspended materials, and the amount of suspending agent can affect stability, amounts for each of these factors can be selected so that the above stability tests are met.

Liquid Viscosity

The composition has a viscosity that allows the composition to be pourable, which is usually below 10,000 mPas. Viscosity is measured using a Brookfield RVT Viscometer using spindle 21 at 20 RPM at 25° C. In one embodiment, the viscosity is less than 5,000 mPas. In other embodiments. the viscosity is less than 1,500 mPas, less than 1,000 mPas, less than 750 mPas, or less than 500 mPas.

Liquid Portion

The composition contains at least one surfactant that is present in an amount that is at least 15% by weight of the composition based on the active amount of the surfactant. In other embodiments, the amount of surfactant is at least 20%, at least 25%, at least 30 %, at least 35%. or at least 40% by weight. In another embodiment, the amount of surfactant ranges from 15% to 45% by weight. The surfactant can be any surfactant or any combination of surfactants. Examples of surfactants include anionic, nonionic, cationic, amphoteric, or zwitterionic.

Anionic surfactants include, but are not limited to, those surface-active or detergent compounds that contain an organic hydrophobic group containing generally 8 to 26 carbon atoms or generally 10 to 18 carbon atoms in their molecular structure and at least one water-solubilizing group selected from sulfonate, sulfate, and carboxylate so as to form a water-soluble detergent. Usually, the hydrophobic group will comprise a C₈-C₂₂ alkyl, or acyl group. Such surfactants are employed in the form of water-soluble salts and the salt-forming cation usually is selected from sodium, potassium, ammonium, magnesium and mono-, di- or tri-C₂-C₃ alkanolammonium, with the sodium, magnesium and ammonium cations again being the usual ones chosen.

The anionic surfactants that are used in the composition of this invention are water soluble and include, but are not limited to, the sodium, potassium, ammonium, and ethanolammonium salts of linear C₈-C₁₆ alkyl benzene sulfonates, alkyl ether carboxylates, C₁₀-C₂₀ paraffin sulfonates, C₈-C₂₅ alpha olefin sulfonates, C₈-C₁₈ alkyl sulfates, alkyl ether sulfates and mixtures thereof.

The paraffin sulfonates (also known as secondary alkane sulfonates) may be monosulfonates or di-sulfonates and usually are mixtures thereof, obtained by sulfonating paraffins of 10 to 20 carbon atoms. Commonly used paraffin sulfonates are those of C12-18 carbon atoms chains, and more commonly they are of C14-17 chains. Paraffin sulfonates that have the sulfonate group(s) distributed along the paraffin chain are described in U.S. Pat. Nos. 2,503,280; 2,507,088; 3,260,744; and 3,372,188; and also in German Patent 735,096. Such compounds may be made to specifications and desirably the content of paraffin sulfonates outside the C14-17 range will be minor and will be minimized, as will be any contents of di- or polysulfonates. Examples of paraffin sulfonates include, but are not limited to HOSTAPUR™ SAS30, SAS 60, SAS 93 secondary alkane sulfonates from Clariant, and BIO-TERGE™ surfactants from Stepan, and CAS No. 68037-49-0.

Pareth sulfate surfactants can also be included in the composition. The pareth sulfate surfactant is a salt of an ethoxylated C₁₀-C₁₆ pareth sulfate surfactant having 1 to 30 moles of ethylene oxide. In some embodiments, the amount of ethylene oxide is 1 to 6 moles, and in other embodiments it is 2 to 3 moles, and in another embodiment it is 2 moles. In one embodiment, the pareth sulfate is a C₁₂-C₁₃ pareth sulfate with 2 moles of ethylene oxide. An example of a pareth sulfate surfactant is STEOL™ 23-2S/70 from Stepan, or (CAS No. 68585-34-2).

Examples of suitable other sulfonated anionic detergents are the well known higher alkyl mononuclear aromatic sulfonates, such as the higher alkylbenzene sulfonates containing 9 to 18 or preferably 9 to 16 carbon atoms in the higher alkyl group in a straight or branched chain, or C₈₋₁₅ alkyl toluene sulfonates. In one embodiment, the alkylbenzene sul fonate is a linear alkylbenzene sulfonate having a higher content of 3-phenyl (or higher) isomers and a correspondingly lower content (well below 50%) of 2-phenyl (or lower) isomers, such as those sulfonates wherein the benzene ring is attached mostly at the 3 or higher (for example 4, 5, 6 or 7) position of the alkyl group and the content of the isomers in which the benzene ring is attached in the 2 or 1 position is correspondingly low. Materials that can be used arc found in U.S. Pat. No. 3,320,174, especially those in which the alkyls are of 10 to 13 carbon atoms.

Other suitable anionic surfactants are the olefin sulfonates, including long-chain alkene sulfonates, long-chain hydroxyalkane sulfonates or mixtures of alkene sulfonates and hydroxyalkane sulfonates. These olefin sulfonate detergents may be prepared in a known manner by the reaction of sulfur trioxide (SO₃) with long-chain olefins containing 8 to 25, preferably 19 to 21 carbon atoms and having the fonnula RCH═CHR₁ where R is a higher alkyl group of 6 to 23 carbons and R₁ is an alkyl group of 1 to 17 carbons or hydrogen to form a mixture of sultones and alkene sulfonic acids which is then treated to convert the sultones to sulfonates. In one embodiment, olefin sulfonates contain from 14 to 16 carbon atoms in the R alkyl group and are obtained by sulfonating an a-olefin.

Examples of satisfactory anionic sulfate surfactants are the alkyl sulfate salts and the and the alkyl ether polyethenoxy sulfate salts having the formula R(OC₂H₄)ₙOSO₃M wherein n is 1 to 12, or 1 to 5, and R is an alkyl group having about 8 to about 18 carbon atoms, or 12 to 15 and natural cuts for example, C₁₂₋₁₄ or C₁₂₋₁₆ and M is a solubilizing cation selected from sodium, potassium, ammonium, magnesium and mono-, di- and triethanol ammonium ions. The alkyl sulfates may be obtained by sulfating the alcohols obtained by reducing glycerides of coconut oil or tallow or mixtures thereof and neutralizing the resultant product.

The ethoxylated alkyl ether sulfate may be made by sulfating the condensation product of ethylene oxide and C₈₋₁₈ alkanol, and neutralizing the resultant product. The ethoxylated alkyl ether sulfates differ from one another in the number of carbon atoms in the alcohols and in the number of moles of ethylene oxide reacted with one mole of such alcohol. In one embodiment, alkyl ether sulfates contain 12 to 15 carbon atoms in the alcohols and in the alkyl groups thereof, e.g., sodium myristyl (3 EO) sulfate.

Ethoxylated C₈₋₁₈ alkylphenyl ether sulfates containing from 2 to 6 moles of ethylene oxide in the molecule are also suitable for use in the invention compositions. These detergents can be prepared by reacting an alkyl phenol with 2 to 6 moles of ethylene oxide and sulfating and neutralizing the resultant ethoxylated alkylphenol.

Other suitable anionic detergents are the C₉-C₁₅ alkyl ether polyethenoxyl carboxylates having the structural formula R(OC₂H₄)ₙOXCOOH wherein n is a number from 4 to 12, preferably 6 to 11 and X is selected from the group consisting of CH₂, C(O)R₁ and 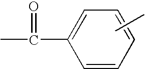
wherein R₁ is a C₁-C₃ alkylene group. Types of these compounds include, but are not limited to, C₉-C₁₁ alkyl ether polyethenoxy (7-9) C(O)CH₂CH₂COOH, C₁₃-C₁₅ alkyl ether polyethenoxy (7-9) 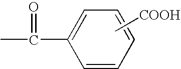
and C₁₀-C₁₂ alkyl ether polyethenoxy (5-7) CH₂COOH. These compounds may be prepared by condensing ethylene oxide with appropriate alkanol and reacting this reaction product with chloracetic acid to make the ether carboxylic acids as shown in U.S. Pat. No. 3,741,911 or with succinic anhydride or phtalic anhydride.

The amine oxide is depicted by the formula: 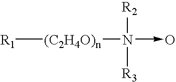
wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms; R₂ and R₃ are each methyl, ethyl, propyl, isopropyl, 2-hydroxyethyl, 2-hydroxypropyl, or 3-hydroxypropyl; and n is from 0 to about 10. In one embodiment, the amine oxides are of the formula: 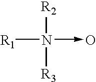
wherein R₁ is a C₁₂₋₁₈ alkyl and R₂ and R₃ are methyl or ethyl. The above ethylene oxide condensates, amides, and amine oxides are more fully described in U.S. Pat. No, 4,316,824. In another embodiment, the amine oxide is depicted by the formula: 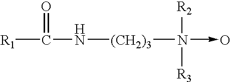
wherein R₁ is a saturated or unsaturated alkyl group having about 6 to about 24 carbon atoms, R₂ is a methyl group, and R₃ is a methyl or ethyl group. The preferred amine oxide is cocoamidopropyl-dimethylamine oxide.

The water soluble nonionic surfactants utilized in this invention are commercially well known and include the primary aliphatic alcohol ethoxylates, secondary aliphatic alcohol ethoxylates alkylphenol ethoxylates and ethylene-oxide-propylene oxide condensates on primary alkanols. such a PLURAFAC™ surfactants (BASF) and condensates of ethylene oxide with sorbitan fatty acid esters such as the TWEEN™ surfactants (ICI). The nonionic synthetic organic detergents generally are the condensation products of an organic aliphatic or alkyl aromatic hydrophobic compound and hydrophilic ethylene oxide groups. Practically any hydrophobic compound having a carboxy hydroxy, amido, or amino group with a free hydrogen attached to the nitrogen can be condensed with ethylene oxide or with the polyhydration product thereof, polyethylene glycol, to form a water-soluble nonionic detergent. Further, the length of the polyethenoxy chain can be adjusted to achieve the desired balance between the hydrophobic and hydrophilic elements.

The nonionic surfactant class includes the condensation products of a higher alcohol (e.g., an alkanol containing about 8 to 18 carbon atoms in a straight or branched chain configuration) condensed with about 5 to 30 moles of ethylene oxide, for example, lauryl or myristyl alcohol condensed with about 16 moles of ethylene oxide (EO), tridecanol condensed with about 6 to moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

In one embodiment, the nonionic surfactants are the NEODOL™ ethoxylates (Shell Co.), which are higher aliphatic, primary alcohol containing about 9-15 carbon atoms, such as C₉-C₁₁ alkanol condensed with 2.5 to 10 moles of ethylene oxide (NEODOL™ 91-2.5 OR -5 OR -6 OR -8), C₁₂₋₁₃ alkanol condensed with 6.5 moles ethylene oxide (NEODOL™ 23-6.5), C₁₂₋₁₅ alkanol condensed with 12 moles ethylene oxide (NEODOL™ 25-12), C₁₄₋₁₅ alkanol condensed with 13 moles ethylene oxide (NEODOL™ 45-13), and the like.

Additional satisfactory water soluble alcohol ethylene oxide condensates are the condensation products of a secondary aliphatic alcohol containing 8 to 18 carbon atoms in a straight or branched chain configuration condensed with 5 to 30 moles of ethylene oxide. Examples of commercially available nonionic detergents of the foregoing type are C₁₁-C₁₅ secondary alkanol condensed with either 9 EO (TERGITOL™ 15-S-9) or 12 EO (TERGITOL™ 15-S-12) marketed by Union Carbide.

Other suitable nonionic surfactants include the polyethylene oxide condensates of one mole of alkyl phenol containing from about 8 to 18 carbon atoms in a straight- or branched chain alkyl group with about 5 to 30 moles of ethylene oxide. Specific examples of alkyl phenol ethoxylates include, but are not limited to, nonyl phenol condensed with about 9.5 moles of EO per mole of nonyl phenol, dinonyl phenol condensed with about 12 moles of EO per mole of phenol, dinonyl phenol condensed with about 15 moles of EO per mole of phenol and di-isoctylphenol condensed with about 15 moles of EO per mole of phenol. Commercially available nonionic surfactants of this type include IGEPAL™ CO-630 (nonyl phenol ethoxylate) marketed by GAF Corporation.

Also among the satisfactory nonionic surfactants are the water-soluble condensation products of a C₈-C₂₀ alkanol with a heteric mixture of ethylene oxide and propylene oxide wherein the weight ratio of ethylene oxide to propylene oxide is from 2.5:1 to 4:1, preferably 2.8:1 to 3.3:1, with the total of the ethylene oxide and propylene oxide (including the terminal ethanol or propanol group) being from 60-85%, preferably 70-80%, by weight. Such detergents are commercially available from BASF and a particularly preferred detergent is a C₁₀-C₁₆ alkanol condensate with ethylene oxide and propylene oxide, the weight ratio of ethylene oxide to propylene oxide being 3:1 and the total alkoxy content being about 75% by weight.

Condensates of 2 to 30 moles of ethylene oxide with sorbitan mono- and tri-C₁₀-C₂₀ alkanoic acid esters having a HLB of 8 to 15 also may be employed as the nonionic detergent ingredient in the described composition. These surfactants are well known and are available from Imperial Chemical Industries under the TWEEN™ trade name. Suitable surfactants include, but are not limited to, polyoxyethylene (4) sorbitan monolaurate, polyoxyethylene (4) sorbitan monostearate, polyoxyethylene (20) sorbitan trioleate and polyoxyethylene (20) sorbitan tristearate.

Other suitable water-soluble nonionic surfactants are marketed under the trade name PLURONIC™. The compounds are formed by condensing ethylene oxide with a hydrophobic base formed by the condensation of propylene oxide with propylene glycol. The molecular weight of the hydrophobic portion of the molecule is of the order of 950 to 4000 and preferably 200 to 2,500. The addition of polyoxyethylene radicals to the hydrophobic portion tends to increase the solubility of the molecule as a whole so as to make the surfactant water-soluble. The molecular weight of the block polymers varies from 1,000 to 15,000 and the polyethylene oxide content may comprise 20% to 80% by weight. Preferably, these surfactants will be in liquid form and satisfactory surfactants are available as grades L 62 and L 64.

The alkyl polysaccharides surfactants, which can be used in the instant composition, have a hydrophobic group containing from about 8 to about 20 carbon atoms, preferably from about 10 to about 16 carbon atoms, or from about 12 to about 14 carbon atoms, and polysaccharide hydrophilic group containing from about 1.5 to about 10, or from about 1.5 to about 4, or from about 1.6 to about 2.7 saccharide units (e.g., galactoside, glucoside, fructoside, glucosyl, fructosyl; and/or galactosyl units). Mixtures of saccharide moieties may be used in the alkyl polysaccharide surfactants. The number x indicates the number of saccharide units in a particular alkyl polysaccharide surfactant. For a particular alkyl polysaccharide molecule x can only assume integral values. In any physical sample of alkyl polysaccharide surfactants there will be in general molecules having different x values. The physical sample can be characterized by the average value of x and this average value can assume non-integral values. In this specification the values of x are to be understood to be average values. The hydrophobic group (R) can be attached at the 2-, 3-, or 4-positions rather than at the 1-position, (thus giving e.g. a glucosyl or galactosyl as opposed to a glucoside or galactoside). However, attachment through the 1-position, i.e., glucosides, galactoside, fructosides, etc., is preferred. In one embodiment, the additional saccharide units are predominately attached to the previous saccharide unit's 2-position. Attachment through the 3-, 4-, and 6-positions can also occur. Optionally and less desirably there can be a polyalkoxide chain joining the hydrophobic moiety (R) and the polysaccharide chain. The preferred alkoxide moiety is ethoxide.

Typical hydrophobic groups include alkyl groups, either saturated or unsaturated, branched or unbranched containing from about 8 to about 20, preferably from about 10 to about 18 carbon atoms. In one embodiment, the alkyl group is a straight chain saturated alkyl group. The alkyl group can contain up to 3 hydroxy groups and/or the polyalkoxide chain can contain up to about 30, preferably less than about 10, alkoxide moieties.

Suitable alkyl polysaccharides include, but are not limited to, decyl, dodecyl. tetradecyl, pentadecyl, hexadecyl, and octadecyl, di-, tri-, tetra-, penta-, and hexaglucosides, galactosides, lactosides, fructosides, fructosyls, lactosyls, glucosyls and/or galactosyls and mixtures thereof.

The alkyl immunosaccharides are relatively less soluble in water than the higher alkyl polysaccharides. When used in admixture with alkyl polysaccharides, the alkyl monosaccharides are solubilized to some extent. The use of alkyl monosaccharides in admixture w ith alkyl polysaccharides is a preferred mode of carrying out the invention. Suitable mixtures include coconut alkyl, di-, tri-, tetra-, and pentaglucosides and tallow alkyl tetra-, penta-, and hexaglucosides.

In one embodiment, the alkyl polysaccharides are alkyl polyglucosides having the formula
R₂O(CₙH₂ₙO)ᵣ(Z)ₓ
wherein Z is derived from glucose, R is a hydrophobic group selected from alkyl, alkylphenyl, hydroxyalkylphenyl, and mixtures thereof in which said alkyl groups contain from about 10 to about 18, preferably from about 12 to about 14 carbon atoms; n is 2 or 3, r is from 0 to 10; and x is from 1.5 to 8, or from 1.5 to 4, or from 1.6 to 2.7. To prepare these compounds a long chain alcohol (R₂OH) can be reacted with glucose, in the presence of an acid catalyst to form the desired glucoside. Alternatively the alkyl polyglucosides can be prepared by a two step procedure in which a short chain alcohol (R₁OH) can be reacted with glucose, in the presence of an acid catalyst to form the desired glucoside. Alternatively the alkyl polyglucosides can be prepared by a two step procedure in which a short chain alcohol (C₁₋₆) is reacted with glucose or a polyglucoside (x=2 to 4) to yield a short chain alkyl glucoside (x=1 to 4) which can in turn be reacted with a longer chain alcohol (R₂OH) to displace the short chain alcohol and obtain the desired alkyl polyglucoside. If this two step procedure is used, the short chain alkylglucosde content of the final alkyl polyglucoside material should be less than 50%, preferably less than 10%, more preferably less than about 5%, most preferably 0% of the alkyl polyglucoside.

The amount of unreacted alcohol (the free fatty alcohol content) in the desired alkyl polysaccharide surfactant is generally less than about 2%, or less than about 0.5% by weight of the total of the alkyl polysaccharide. For some uses it is desirable to have the alkyl monosaccharide content less than about 10%.

“Alkyl polysaccharide surfactant” is intended to represent both the glucose and galactose derived surfactants and the alkyl polysaccharide surfactants. Throughout this specification, “alkyl polyglucoside” is used to include alkyl polyglycosides because the stereochemistry of the saccharide moiety is changed during the preparation reaction.

In one embodiment, APG glycoside surfactant is APG 625 glycoside manufactured by the Henkel Corporation of Ambler, Pa. APG25 is a nonionic alkyl polyglycoside characterized by the formula:
CₙH₂ₙ₊₁O(C₆H₁₀O₅)ₓH
wherein n=10 (2%); n=122 (65%); n=14 (21-28%); n=16 (4-8%) and n=18 (0.5%) and x (degree of polymerization)=1.6. APG 625 has: a pH of 6 to 10 (10% of APG 625 in distilled water); a specific gravity at 25° C. of 1.1 g/ml: a density at 25° C. of 9.1 lbs/gallon; a calculated HLB of 12.1 and a Brookfield viscosity at 35° C. 21 spindle, 5-10 RPM of 3,000 to 7,000 cps.

The zwitterionic surfactant can be any zwitterionic surfactant. In one embodiment. the zwitterionic surfactant is a water soluble betaine having the general formula 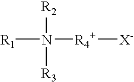
wherein X⁻ is selected from COO⁻ and SO₃⁻ and R₁ is an alkyl group having 10 to about 20 carbon atoms, or 12 to 16 carbon atoms, or the amido radical: 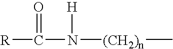
wherein R is an alkyl group having about 9 to 19 carbon atoms and n is the integer 1 to 4; R₂ and R₃ are each alkyl groups having 1 to 3 carbons and preferably 1 carbon; R₄ is an alkylene or hydroxyalkylene group having from 1 to 4 carbon atoms and, optionally, one hydroxyl group. Typical alkyldimethyl betaines include, but are not limited to, decyl dimethyl betaine or 2-(N-decyl-N, N-dimethyl-ammonia) acetate, coco dimethyl betaine or 2-(N-coco N,N-dimethylammonia) acetate, myristyl dimethyl betaine, palmityl dimethyl betaine, lauryl dimethyl betaine, cetyl dimethyl betaine, stearyl dimethyl betaine, etc. The amidobetaines similarly include, but are not limited to, cocoamidoethylbetaine, cocoamidopropyl betaine and the like. The amidosulfobetaines include, but are not limited to, cocoamidoethylsulfobetaine, cocoamidopropyl sulfobetaine and the like. In one embodiment, the betaine is coco (C₈-C₁₈) amidopropyl dimethyl betaine. Three examples of betaine surfactants that can be used are EMPIGEN™ BS/CA from Albright and Wilson. REWOTERIC™ AMB 13 and Goldschmidt Betaine L7.

The composition may also contain solvents or salts to modify the cleaning. stability and rheological properties of the composition.

Solvents can include any water soluble solvents. Water soluble solvents include, but are not limited to, C₂₋₄ mono, dihydroxy, or polyhydroxy alkanols and/or an ether or diether, such as ethanol, isopropanol, diethylene glycol monobutyl ether, dipropylene glycol methyl ether, diproyleneglycol monobutyl ether, propylene glycol n-butyl ether, propylene glycol, and hexylene glycol, and alkali metal cumene, alkali metal toluene, or alkali metal xylene sulfonates such as sodium cumene sulfonate and sodium xylene sulfonate. In some embodiment, the solvents include ethanol and diethylene glycol monobutyl ether, both of which are miscible with water. Urea can be optionally used at a concentration of 0.1% to 7 weight %.

Salts can include any desirable salt. Examples of salts include, but are not limited to, sodium chloride and magnesium sulfate.

Additional optional ingredients may be included to provide added effect or to make the product more attractive. Such ingredients include, but are not limited to, perfumes, fragrances, abrasive agents, disinfectants, radical scavengers, bleaches, chelating agents, antibacterial agents/preservatives, optical brighteners, hydrotropes, or combinations thereof.

In some embodiments, preservatives can be used in the composition at a concentration of 0 wt. % to 3 wt. %, more preferably 0.01 wt. % to 2.5 wt. %. Examples of preservatives include, but are not limited to, benzalkonium chloride; benzethonium chloride,5-bromo-5-nitro-1,3dioxane; 2-bromo-2-nitropropane-1,3-diol; alkyl trimethyl ammonium bromide; N-(hydroxymetliyl)-N-(1,3-dihydroxy methyl-2,5-dioxo-4-imidaxolidinyl-N′-(hydroxy methyl) urea; 1-3-dimethyol-5,5-dimethyl hydantoin; formaldehyde; iodopropyl butyl carbamate, butyl paraben; ethyl paraben; methyl paraben; propyl paraben, mixture of methyl isothiazolinone/methyl-chloroisothiazoline in a 1:3 wt. ratio; mixture of phenoxythanol/butyl paraben/methyl paraben/propylparaben; 2-phenoxyethanol; tris-hydroxyethyl-hexahydrotriazine; methylisothiazolinone; 5-chloro-2-methyl -4-isothiazolin-3-one; 1,2-dibromo-2,4-dicyanobutane; 1-(3-chloroalkyl)-3,5,7-triaza-azoniaadam- antane chloride; and sodium benzoate.

Generally, water is included in the composition. The amount of water is variable depending on the amounts of other materials added to the composition.

The compositions can be made by simple mixing methods from readily available components which, on storage, do not adversely affect the entire composition. Mixing can be done by any mixer that forms the composition. Examples of mixers include, but are not limited to static mixers and in-line mixers. Solubilizing agents such as a C₁-C₃ alkyl substituted benzene sulfonate such as sodium cumene or sodium xylene sulfonate and mixtures thereof can be used at a concentration of 0.5 wt. % to 10 wt. % to assist in solubilizing the surfactants.

Container

The composition can be provided in any type of container that is compatible with the composition. Non-limiting examples of containers are made from plastic or glass. For consumer convenience, plastic may be chosen. The plastic can be any type of plastic. Examples of plastic include, but are not limited to, polyethylene tetra phthalate (PET), polyethylene, polypropylene, or polyvinyl chloride. The plastic bottle preferably does not overly affect the visual impact of the materials. Container properties, such as clarity, gloss, color, and shape can be selected to provide a desired aesthetic effect.

In one embodiment, the container has clarity of at least 15% transmittance as measured by the transmittance test described below. In another embodiment, the transmittance is >50%, and in another embodiment the transmittance is >90% transmittance. The transmittance can be up to 100%.

In one embodiment, the combined transmittance of the container and the liquid portion is at least 15%. In other embodiments, the transmittance can be >50%, >90%, or up to 100%. The transmittance is measured along a longest horizontal path from the front of the container to the rear of the container.

In one embodiment, the container has a gloss of 10 to 500 gloss units as measured at 60 degrees according to the test described below. In another embodiment, the gloss is from 10 to 100 as measured at 60 degrees.

The container can be any color or uncolored. The container can be opaque, but it is preferred that the container is transparent or translucent. In one embodiment, the container is transparent and uncolored. In another embodiment, the container is transparent and colored. In one embodiment, the color intensity is not more than 20 chroma units as measured by the test described below.

The container can be of any desired shape. Types of shapes include, but are not limited to, round, triangular, cylindrical, oval, asymmetrical, or waisted (having defined shoulders and hips). In one embodiment, the container has a shape as the defined by the side to side, front to back and height dimensions below:

| | Max, mm | Min, mm |
|---|---|---|
| Side to Side | 250 | 30 |
| Front to Back | 160 | 30 |
| Height | 350 | 60 |

In one embodiment, the greatest side to side dimension of the container is greater than the greatest front to back dimension of the container. In another embodiment, the height of the container is greater than the greatest front to back dimension and the greatest side to side dimension of the container.

Label

The composition is intended to be distributed to a consumer in a container with a label. The label identifies the brand, manufacturer, and type of product, and it can include any safety or regulatory information, usage instructions, or other useful information. Generally. extensive information must be contained in a limited amount of space. Labels can be opaque, translucent (clear), or have a transmittance between opaque and clear. In one embodiment, the label has transparency of at least 15% transmittance. In other embodiments, the transmittance is >50%, >90%, or up to 100% in areas not covered by printing. The printing on the label can be designed with the same level of transmittance as long as the printing can be read. In one embodiment, the combined transmittance of the label, the container, and the liquid portion is at least 15% in areas not covered by printing. In other embodiments, the transmittance is >50%, >90%, or up to 100% in areas not covered by printing.

The label can be adhered to the container by any desired method. Examples include, but are not limited to, permanent, peel-off, or peel off leaving a residual but smaller portion of the overall label. The label can be textured, contain any desired graphics including a hologram, 3D effects, light reflection, or plain printing.

Closure

The composition can be distributed to the consumer in a container with a closure to prevent spillage and evaporation, and it can aid in dispensing. Any type of closure can be used with the container that allows for the dispensing of the composition. Examples of closures include, but are not limited to, push pull, flip top, spout, valve, or pump type. These allow for easy dispensing. These types can provide for a flow rate of at least 1 ml/sec. (as measured by volume dispensed over time). The closure opening diameter can be adjusted as desired for product viscosity.

Transmittance refers to the amount of light that can be transmitted through an object as a fraction of the incident light. The longer the path length, the more the light intensity detectable on the side opposite the incident light is attenuated. Transmittance can be measured using a Shimadzu UV-160U instrument according to the manufacturer's instructions. A sample to be measured is placed in a 1 cm cuvette and placed in the machine. The wavelength of light used is 720 nm. Transmittance is read directly from the instrument as % transmittance.

Surface gloss is measured by using a Gardner Micro TRI Gloss Meter by following the instructions given for operating the instrument at 60°. For transparent or translucent surfaces a nonreflective black backing is placed under the sample so that transmitted light does not contribute to the gloss measurement.

Measurements of lightness, chroma, and hue angle are done with an X-Rite SP60 Sphere Spectrophotometer with 4 mm aperture. For transparent or translucent liquids, the instrument is placed in its stand fitted with a holder for a rectangular 10 mm, Starna glass calorimeter cell. The Starna cell is filled with the sample, the cap placed on top and the cell placed in the holder. The sphere spectrophotometer is triggered to initiate the measurement. Although this method does not give the same results as transmission color measurements, the measurements are correct relative to other measures done by this method so that comparisons of chroma, hue angle and lightness can be done. Therefore, to measure solid samples (such as packaging materials) a sample of the material is cut to fit in the Starna cell and the measurement is done in the same way after placing the sample in the cell. Measurements are done under conditions of the 10° observer and fluorescent light. Optionally, other light sources, such as incandescent or sunlight, can be used if it is desired to optimize the viewing of the composition under those light sources. For standardized measurements. fluorescent lighting is used.

The following example illustrates a composition of the invention. Unless otherwise specified, all percentages are by weight. The exemplified composition is illustrative only and does no limit the scope of the invention. Unless otherwise specified. the proportions in the examples and elsewhere in the specification are by active weight. The active weight of a material is the weight of the material itself excluding water or other materials that may be present in the supplied form of the material.

TABLE 1

| Material | wt/wt % |
|---|---|
| Water | QS |
| C12-15 Alcohol EO 1.3:1 Ammonium Sulfate | 12.2 |
| Mg Dodecyl Benzene Sulfonate | 9.3 |
| Lauramidopropyldimethylamine oxide | 4.3 |
| Na Dodecyl Benzene Sulfonate | 3.9 |
| Ethanol | 3.5 |
| Sodium Xylene Sulfonate (40%) | 2.0 |
| Myristamidopropylamine oxide | 1.4 |
| Fragrance | 0.5 |
| FD&C Green No. 3, CI42053 Dye | 0.02 |
| Gellan Gum | 0.125 |
| Pentasodium Pentetate | 0.13 |
| DMDM Hydantoin | 0.12 |
| LIPOSHERE ™ 0258 spheres (blue) | 0.5 |
| TOTAL | 100 |
| % Transmittance | at least 15% |

What is claimed is:

1. A composition comprising suspended material and a liquid portion comprising at least one surfactant, wherein
a) the surfactant is present in the composition in an amount that is at least 15% by weight of the composition based on active weight of the surfactant;
b) the composition has a viscosity less than 10,000 mPas as measured at 25° C.;
c) the liquid portion has a transmittance, as measured by visible spectroscopy, of at least 15%; and
d) the suspended material has a particle size of 100 to 2500 microns.

2. The composition of claim 1, wherein the liquid portion, at least a portion of the suspended material, or both has a color.

3. The composition of claim 1, wherein the suspended material comprises suspended material of more than one color.

4. The composition of claim 1, wherein the suspended material comprises suspended material of more than one shape.

5. The composition of claim 1, wherein the suspended material comprises suspended material of more than one size.

6. The composition of claim 1, wherein the suspend material comprises suspended material of more than one color, of more than one shape, and of more than one size.

7. The composition of claim 1, wherein the suspended material has a shape chosen from spherical, polyhedral, cubic, box, tetrahedral, irregular three dimensional shapes, flat polygons, triangles, rectangles, squares, pentagons hexagons, octagons, stars, characters, animals, plants, objects, and cars.

8. The composition of claim 1, wherein at least a portion of the suspended material is visually observable by a person.

9. The composition of claim 1, wherein more than 50% of the suspended material is visually observable to a person.

10. The composition of claim 1, wherein the suspended material is present in an amount of 0.01 and 10% by weight of the total composition.

11. The composition of claim 1. wherein the liquid portion has a hue that is not a complementary hue to more than 50% of the suspended material.

12. The composition of claim 1, wherein the liquid portion has a chromia that is different from more than 50% of the suspended material.

13. The composition of claim 1, wherein the liquid portion has a hue that is not a complementary hue to more than 50% of the suspended material, and the liquid portion has a chroma that is different from more than 50% of the suspended material.

14. The composition of claim 13, wherein the liquid portion has a transmittance of at least 95%.

15. The composition of claim 1, wherein the liquid portion has a transmittance of at least 95%.

16. The composition of claim 1, wherein the composition keeps at least 90% of the suspended material suspended for at least one year at room temperature.

17. The composition of claim 1, wherein the composition keeps at least 90% of the suspended material suspended for at least 18 weeks at 40.5° C.

18. The composition of claim 1, wherein the composition keeps at least 90% of the suspended material suspended for at least 2 weeks at −10° C.

19. The composition of claim 1, wherein the composition keeps at least 90% of the suspended material suspended for at least 3 weeks at 4.5° C.

20. The composition of claim 1, wherein the composition is in a container.

21. The composition of claim 20, wherein the container has a hue that is not a complementary hue to more than 50% of the suspended material.

22. The composition of claim 20, wherein the container and the liquid portion each have a hue that is not a complementary hue to more than 50% of the suspended material.

23. The composition of claim 20, wherein the container has a chroma that is different from more than 50% of the suspended material.

24. The composition of claim 20, wherein the container and the liquid portion each have a chroma that is different from more than 50% of the suspended material.

25. The composition of claim 20, wherein the container has a hue that is not a complementary hue to more than 50% of the suspended material, and the container has a chroma that is different from more than 50% of the suspended material.

26. The composition of claim 20, wherein the liquid portion and the container each have a hue that is not a complementary hue to more than 50% of the suspended material, and the liquid portion and the container each have a chromia that is different fiom more than 50% of the suspended material.

27. The composition of claim 20, wherein the container has a gloss of 10 to 500 gloss units as measured at 60 degrees.
